(19) United States
(12) Patent Application Publication
(10) Pub. No.: US 2021/0056656 A1
(43) Pub. Date: Feb. 25, 2021

(54) ROUTING FRAMEWORK WITH LOCATION-WISE RIDER FLEXIBILITY IN SHARED MOBILITY SERVICE SYSTEM

(71) Applicants: Ford Global Technologies, LLC, Dearborn, MI (US); Massachusetts Institute of Technology, Cambridge, MA (US)

(72) Inventors: Yue GUAN, Cambridge, MA (US); Anuradha ANNASWAMY, West Newton, MA (US); Ling ZHU, Canton, MI (US); Hongtei Eric TSENG, Canton, MI (US); Huizhu Crystal WANG, Bloomfield Hills, MI (US)

(21) Appl. No.: 16/547,062

(22) Filed: Aug. 21, 2019

(51) Int. Cl. G06Q 50/30; G06Q 30/02; G01C 21/34

(52) U.S. Cl. CPC G06Q 50/30; G01C 21/3438; G06Q 30/0284

(57) ABSTRACT

A ride-sharing system may include a database configured to maintain a plurality of shuttle routes for ride-sharing and a server configured to receive a ride-sharing request indicating desire to join a ride-share and including a maximum walk distance to a pick-up or drop-off location of the desired route, and transmit, in response to the ride-sharing request, at least one selected route having a route walk distance to the pick-up or drop-off location not exceeding the maximum walk distance.

### TECHNICAL FIELD

Aspects of the disclosure generally relate to systems having routing framework with location-wise rider flexibility in shared mobility service.

### BACKGROUND

Mobility on Demand (MoD) solutions may provide alternatives other than conventional transportation options. One example is shared vehicles for passengers having similar trip itineraries. MoD is becoming increasingly popular in urban settings with the increase technology of mobile devices. Shared MoD solutions that involve multiple passenger transportation may provide an ideal combination of conveniences, flexibility, and affordability to passengers.

### SUMMARY

A ride-sharing system may include a database configured to maintain a plurality of shuttle routes for ride-sharing and a server configured to receive a ride-sharing request indicating desire to join a ride-share and including a maximum walk distance to a pick-up or drop-off location of the desired route, and transmit, in response to the request, at least one selected route having a route walk distance to the pick-up or drop-off location not exceeding the maximum walk distance.

A method for selecting a route for a ride-sharing system, may include receiving a ride-sharing request indicating a desire to join a ride-share and including a user-defined maximum walk distance to a pick-up or drop-off location of a desired route; and transmitting, in response to the request, at least one selected route having a route walk distance to the pick-up or drop-off location not exceeding the maximum walk distance.

A ride-sharing system may include a database configured to maintain a plurality of shuttle routes for ride-sharing; and a server configured to receive a ride-sharing request indicating desire to join a ride-share and including a maximum walk distance to a pick-up or drop-off location of the desired route, a start location and an end location, and select, in response to the ride-sharing request, at least one route having a route walk distance to the pick-up or drop-off location not exceeding the maximum walk distance, the selected route being determined based at least in part on an overlap of the minimum walk distance of the request with at least one other minimum walk distance of another ride-sharing request, and transmit an offer for the selected route, the offer including a fare, the fare being discounted from a regular fare, the pick-up location, drop-off location, and time window, wherein the amount of discount increasing as the maximum walk distance increases, wherein the discount increases as the number of other ride-sharing requests that overlap with the maximum walk distance increases.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example diagram including a vehicle configured to access telematics servers and a mobile device having a platoon subscription application;

FIG. 2 illustrates an example of ride-sharing system;

FIG. 3A illustrates a route system without a space window;

FIG. 3B illustrates the route system with a space window; and

FIG. 4 illustrates a process for the ride-sharing system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Ride-sharing and Mobility on Demand (MoD) is becoming increasingly popular with users of mobile devices and urban infrastructure. MoD solutions may provide several alternatives to the conventional transportation options, including ride-sharing of passengers with similar trip itineraries. Shared MoD solutions involving multi-passenger transportation may provide an ideal combination of convenience, flexibility, and affordability to passengers. Besides the beneficial impart for passengers, shared mobility may also provide a social benefit. Further, shared mobility may drastically reduce the number of vehicles on the road, thus decreasing environmental impact and traffic congestion.

Interest in shared mobility may be increased as rider flexibility increases. That is, the more flexible a rider is willing to be with respect to drop-off and pick-up locations and times, the more available ride-sharing may be due to the higher likelihood for a rider to match a given ride-sharing option.

Disclosed herein is a shared MoD system that uses routing framework with location-wise rider flexibility for operating multi-passenger shuttles. The system implements a user defined space window that allows for flexibility with respect ride-sharing. The space window allows the passenger to walk for a certain distance, both before being picked up and after being dropped off. This allows for a dynamic shuttle service that having a wider range for passenger pick-ups, depending on the user defined space window.

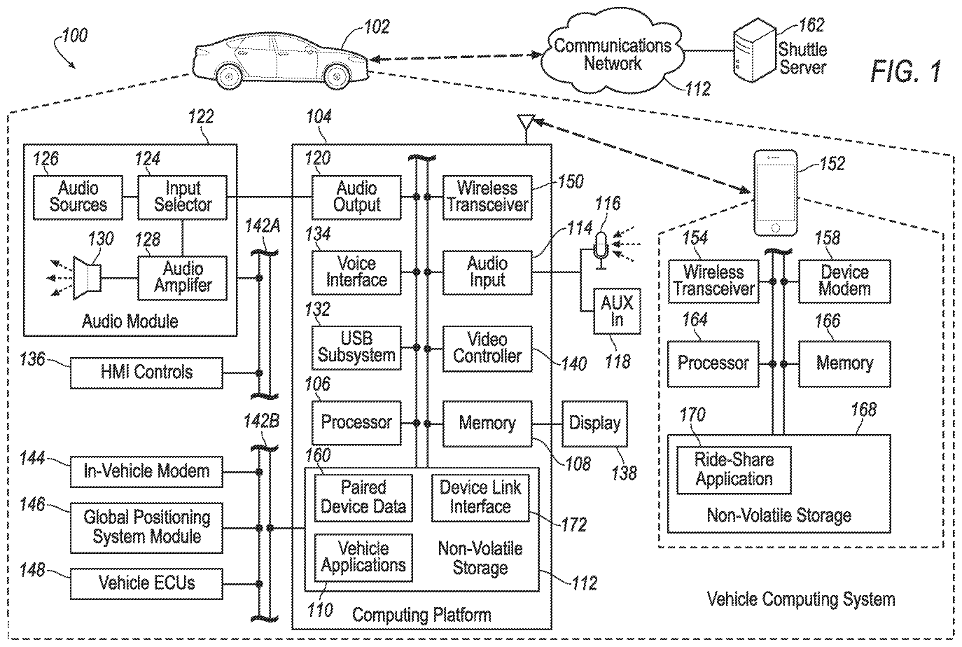

FIG. 1 illustrates an example system 100 including a vehicle 102 configured to access telematics servers and a mobile device 152 having a ride-sharing application 170. The vehicle 102 may include various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the vehicle 102 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM), frequency modulated (FM) or satellite digital audio radio service (SDARS) signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. An example spoken dialog system is described in U.S. Pat. No. 8,400,332, which is incorporated in its entirety by reference herein. The voice interface 134 may support speech recognition from audio received via the microphone 116 according to grammar associated with available commands, and voice prompt generation for output via the audio module 122. Different decoding speech strategies may be used, such as, phonetic, isolated word, word spotting, phrase recognition, large vocabulary continuous speech (LVCSR), etc. In some examples, different grammar languages and speech recognition engines may be utilized for the different strategies. The voice interface 134 may utilize probabilistic speech techniques using the grammar in comparison to the input speech. In many cases, the voice interface 134 may include a standard user profile tuning for use by the speech recognition functions to allow the speech recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

In some examples, a push-to-talk button may be configured to cause voice interface 134 to begin speech recognition. In another example, an “Open Mic” feature may be implemented where the user simply begins to speak without pressing a button. This may be implemented with a voice operated switch (VOX) or with an advanced LVCSR engine that activates for a predetermined set of phrases or words (e.g., a name of the system followed by please, followed by one of a specific set of verbs). The voice interface 134 may also support barge-in, whereby the speech synthesizer begins to provide a prompt before the user has finished the sentence (which is typical of natural speech where a listener begins to speak as soon as they understand the sentence, but before it is completed). Barge-in may also allow a dialog system to intentionally initiate a dialog during moments of silence, or to interrupt and ongoing conversation. This may be used as a tactic for conveying urgency, thus getting the user's attention.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to incorporate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, wearable devices, E-textiles or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention. In some vehicles 102, the computing platform 104 wireless transceiver 154 may be configured to provide hotspot functionality to user's mobile devices 152.

When a mobile device 152 that supports network connectivity is paired with the computing platform 104, the mobile device 152 may allow the computing platform 104 to use the network connectivity of the device modem 158 to communicate over the communications network 156 with the remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications loaded to a memory 166 of the mobile device 152 from storage medium 168 of the mobile device 152. In some examples, the mobile applications may be configured to communicate with the computing platform 104 via the wireless transceiver 154 and with the remote telematics server or shuttle server 162 or other network services via the device modem 158. The computing platform 104 may also include a device link interface 172 to facilitate the integration of functionality of the mobile applications into the grammar of commands available via the voice interface 134. The device link interface 172 may also provide the mobile applications with access to vehicle information available to the computing platform 104 via the in-vehicle networks 142. An example of a device link interface 172 may be the SYNC APPLINK component of the SYNC system provided by The Ford Motor Company of Dearborn, Mich.

A ride-sharing application 170 may be an example of an application installed to the mobile device 152 and configured to utilize the device link interface 172 to interact with the computing platform 104. When connected to the vehicle 102, the ride-sharing application 170 may be configured to utilize information from vehicle sensors, actuators and electronic control units made available via the vehicle bus 142. The ride-sharing application 170 may also be configured to operate when untethered from the vehicle 102, such as when the user is riding public transportation or walking. The ride-sharing application 170 may be further configured to communicate with servers (e.g., server 162) via the communications network 156, as discussed in detail below. The user may interact with the ride-sharing application 170 through the HMI of the mobile device 152, via a web interface, or via the HMI of the vehicle 102, to avoid distraction while driving.

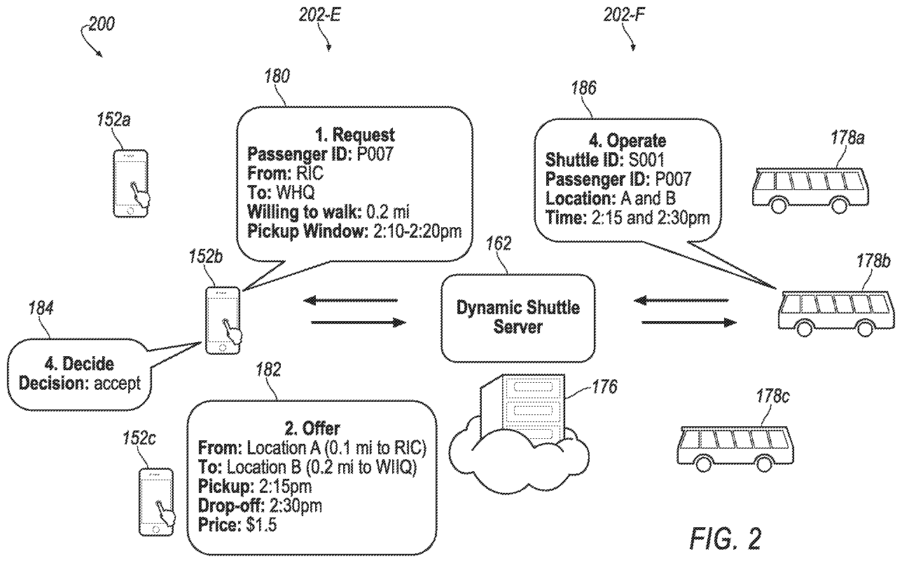

FIG. 2 illustrates an example of ride-sharing system 200 including the shuttle server 162 and a plurality of mobile devices 152 including a first mobile device 152a, a second mobile device 152b, and a third mobile device 152c. Each mobile device 152 may include the ride-sharing application 170, illustrated in FIG. 1. As explained above, the mobile devices 152 may be in communication with the shuttle server 162. The shuttle server 162 may also be in communication with various shuttle provider vehicles 178. The shuttle provider vehicles 178 may be any vehicle capable of transporting one or more passengers from one location to another and may include vehicles of mass transportation systems such as busses, rail-based trained, air-based vehicles such as plane, helicopters, etc. The vehicles 178 may be automobiles, bicycles, scooters, etc. In some instances, users may use their own vehicles as part of the ride-sharing system 200.

Each shuttle vehicle 178 may be associated with a specific route or location. Further, each shuttle vehicle 178 may be associated with various locations, such as a pick-up location and a drop-off location. A route database 176 may maintain various vehicle routes, locations, etc. The route may define the pick-up and drop-off locations, as well as the approximate pick-up and drop-off times, etc. The routes may be generated based on an optimization routine. The routine may take into consideration capacity constraints, legitimate constraints, maximum position shift constraint, and departure constraint. The routing mechanism may be as follows:

Minimize {C=γ1Σᵢ₌₁^{N}tᵢ+γ2Σₖ₌₁ⁿ(α₁WaitTₖ+α₂RideTₖ+γ₃^{p}WalkTₖ^{p}+α₃^{d}WalkTₖ^{d})}

which represents a weighted minimum sum of various time costs, both on the shuttle side and on the passenger side where:

tᵢ represents the time taken by the shuttle to complete the i^{th} trip segment,

WaitTₖ denotes the waiting time,

RideTₖ denotes the riding time,

WalkTₖ^{p}, denotes the walking time before being picked up,

WalkTₖ^{d} denotes the walking time after being dropped off,

k denotes the passenger, and

γ₁, γ₂, α₁, α₂, α₂^{p}, and α₃^{d} are nonnegative weights.

The optimization routine may provide favorable routes for both passengers and shuttles.

The ride-sharing application 170 may receive, via the HMI of the mobile device 152, user settings and selections. The ride-sharing application 170 may receive a ride-sharing request 180. The request 180 may include a passenger identification, a start location and an end location. These locations may be GPS coordinates, addresses, points of interest, the user's current location, etc. The request 180 may also define a space window defining the feasible routing points whose distance from the requested pick-up or drop-off location does not exceed the distance that the passenger is willing to walk. That is, the space window is the set of feasible locations that the shuttle picks up or drops off the passenger according to the pre-specified maximum walk distance. In the example shown in FIG. 2, the user is willing to walk 0.2 miles. This may be the distance that the passenger is willing to walk both to the pick-up location and from the drop-off location. Additionally or alternatively, the request 180 may define a start location space window and an end location space window, where the distance defined by each of the windows differ from one another. The request 180 may also define a time window of service.

The shuttle server 162 may receive the request 180, process the request 180 and return an offer 182 in response to the request. The offer 182 may include one or more possible ride-sharing opportunities. Each opportunity may include a pick-up location and an associated walk-time to the pick-up location, as well as a drop-off location and an associated walk-time from the drop-off location to the end location defined in the request 180. The offer 182 may also define a pick-up time and a drop-off time. The offer 182 may also include the fare, or price for the ride. The fare may be charged directly to the user using a pre-established debit system via the ride-sharing application 170.

The fare may change based on the request 180, the route, etc. The fare may also change based on the user defined window. For example, the fare may be discounted to encourage a larger window, thus allowing for greater ride-sharing. As the window distance increases, the discount of the fare may increase. Furthermore, the more popular of a ride-share, the more the fare may decrease. In some instances, the more people that have overlapping pick-up locations may cause the fare to decrease. That is, the discount may increase as the number of other requests that overlap with the maximum walk distance increases.

Once the mobile device 152 receives the offer 182 via the ride-sharing application, the mobile device 152 may receive a response 184 to the offer 182 via user input at the HMI of the mobile device 152. The response 184 may include either an acceptance of the ride-sharing opportunity or a declination of the ride-sharing opportunity. This response to the offer 182 may be transmitted to the server 162.

If the response 184 indicates an acceptance of the offer 182, the shuttle server 162 may transmit such acceptance 186 to the shuttle vehicle 178. The acceptance 186 may include the passenger ID.

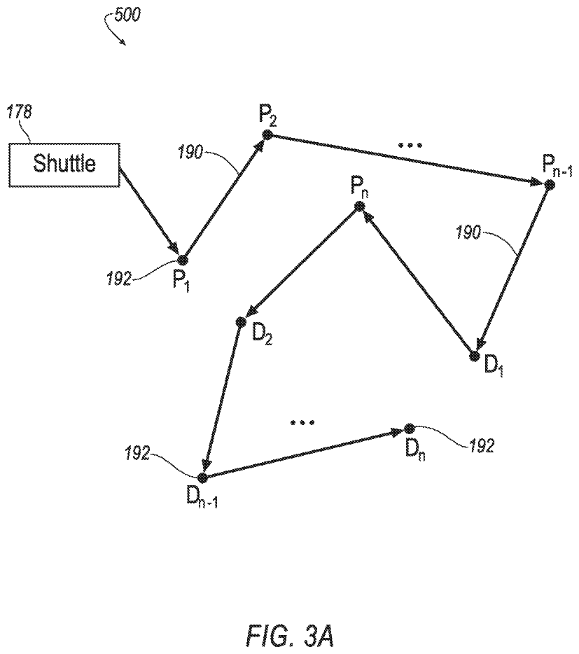

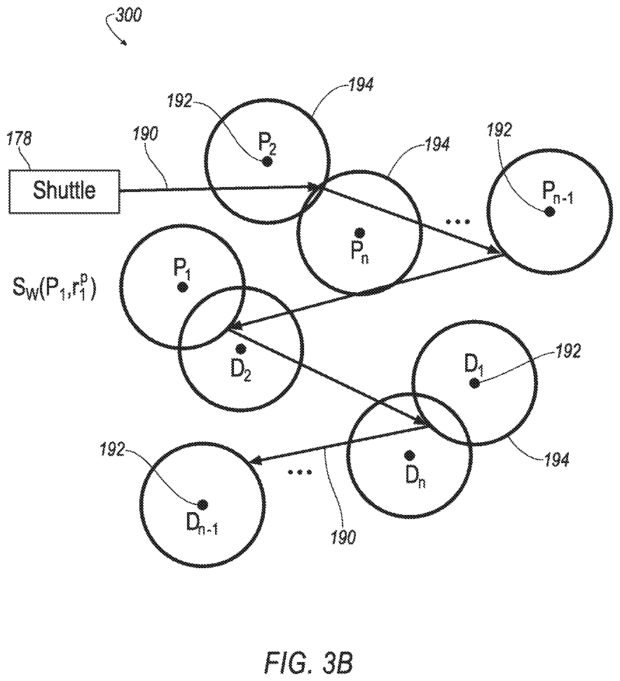

FIG. 3A illustrates a route system 300 including various vehicle routes 190 with various shuttle locations 192. The shuttle locations 192 may be both drop-off locations (e.g., D₁, D₂, Dₙ₋₁, Dₙ) and pick-up locations (e.g., P₁, P₂, Pₙ₋₁, Pₙ) or may be one or the other. The shuttle 178 may provide routing to n passengers with customer specified pickup locations Pₙ and drop-off locations Dₙ for passenger n. Without the space window, the shuttle 178 may stop at each specified location and has a total of eight stops.

FIG. 3B illustrates the route system 300 including the space window 194 is also illustrated for each location 192. With the space windows 194, a semi-door-to-door mode may be implemented. In this mode, fewer stops, e.g., five stops, are required. The user defined space windows 194 allow for greater flexibility with respect to pick-up and drop-off locations, decreasing the number of stops while increasing the number of ride-sharers.

The space windows 194 may greatly decrease the price of anarchy (PoA), which is the cost ratio of all agents acting in a decentralized manner. The proposed space windows may associate asymmetries between driving time and walking time, such as one-ways, pedestrian only lanes, etc. Short walking distance for a passenger in such cases may result in improvements in the shuttle route. By rewarding the passengers for provided flexibility, the overall customer experience may be improved as well.

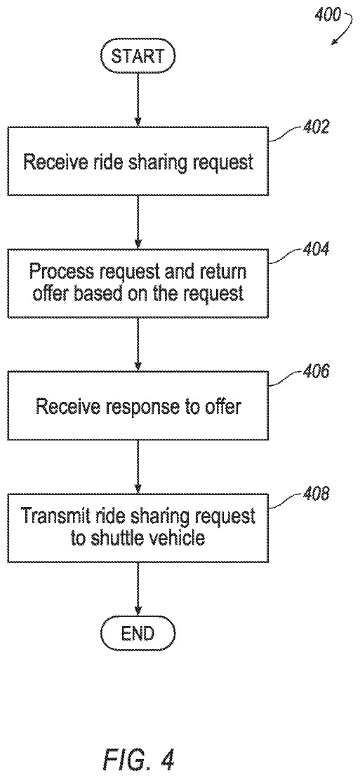

FIG. 4 illustrates an example process 400 for the ride-sharing system 200. The process 400 begins at block 402 where the server 162 receives a ride-sharing request 180. As explained, the ride-sharing request may include passenger ID, a start location and an end location, the distance the passenger is willing to walk, as well as a pick-up window. The request 180 may also include the passenger's current location.

At block 404, the server 162 may process the request 180 and return an offer 182 in response to the request 180. The offer 182 may include one or more possible ride-sharing routes, each including a pick-up location and an associated walk-time to the pick-up location, as well as a drop-off location and an associated walk-time from the drop-off location to the end location defined in the request 180. The offer 182 may also define a pick-up time and a drop-off time. The offer 182 may also include the fare, or price for the ride. The offer 182 may be generated based on the request details and the optimization routine and the routes within the route database 176 as described above. The route or routes may be selected based on the selected route having a route walk distance that do not exceed the maximum walk distance or window defined by the user.

The route may also be selected based on an overlap of the maximum walk distance of the request with at least one other maximum walk distance of another request. The offer 182 may include updated locations 192 of the pick-up and drop-off based on the window 194 defined by the user in the request 180 and the overlap with other windows. Thus, the pick-up and drop-off locations may be modified based on a calibration of the windows 194, other ride-sharing requests, and typical routes within the route database 176.

At block 406, the server 162 may receive a response 184 from the mobile device 152. The response 184 may include an acceptance of declination of the offer 182 by the user.

At block 408, the server 162, in response to receiving an acceptance via the response 184, may proceed to send such acceptance 186 to the shuttle vehicle 178. The acceptance 186 may include the passenger ID, as well as other details of the request 180.

The process 400 may then end.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A ride-sharing system, comprising:
a database configured to maintain a plurality of shuttle routes for ride-sharing;
a server configured to
receive a ride-sharing request indicating desire to j oin a ride-share and including a maximum walk distance to a pick-up or drop-off location of the desired route; and
transmit, in response to the ride-sharing request, at least one selected route having a route walk distance to the pick-up or drop-off location not exceeding the maximum walk distance.

2. The system of claim 1, wherein the selected route is determined based at least in part on an overlap of the minimum walk distance of the request with at least one other minimum walk distance of another ride-sharing request.

3. The system of claim 1, wherein the server is further configured to transmit an offer for the selected route, the offer including a fare, the fare being discounted from a regular fare, the amount of discount increasing as the maximum walk distance increases.

4. The system of claim 3, wherein the discount increases as the number of other ride-sharing requests that overlap with the maximum walk distance increases.

5. The system of claim 1, wherein the server is further configured to transmit the ride-sharing request to a shuttle vehicle associated with the selected route in response to receiving an acceptance of the offer.

6. The system of claim 1, wherein the offer includes the pick-up location, drop-off location, a time window, and a fare of the trip.

7. The system of claim 1, wherein the ride-sharing request includes a passenger identification, a start location, and an end location.

8. A method for selecting a route for a ride-sharing system, comprising:
receiving a ride-sharing request indicating a desire to join a ride-share and including a user-defined maximum walk distance to a pick-up or drop-off location of a desired route; and
transmitting, in response to the request, at least one selected route having a route walk distance to the pick-up or drop-off location not exceeding the maximum walk distance.

9. The method of claim 8, wherein the selected route is determined based at least in part on an overlap of the minimum walk distance of the request with at least one other minimum walk distance of another ride-sharing request.

10. The method of claim 8, further comprising transmitted an offer including a fare, the fare being discounted from a regular fare, the amount of discount increasing as the maximum walk distance increases.

11. The method of claim 10, wherein the discount increases as the number of other ride-sharing requests that overlap with the maximum walk distance increases.

12. The method of claim 8, further comprising transmitting the ride-sharing request to a shuttle vehicle associated with the selected route in response to receiving an acceptance of the offer.

13. The method of claim 8, wherein the offer includes the pick-up location, drop-off location, a time window, and a fare of the trip.

14. The method of claim 8, wherein the ride-sharing request includes a passenger identification, a start location and an end location.

15. A ride-sharing system, comprising:
a database configured to maintain a plurality of shuttle routes for ride-sharing;
a server configured to
receive a ride-sharing request indicating desire to join a ride-share and including a maximum walk distance to a pick-up or drop-off location of the desired route, a start location and an end location; and
select, in response to the ride-sharing request, at least one route having a route walk distance to the pick-up or drop-off location not exceeding the maximum walk distance, the selected route being determined based at least in part on an overlap of the minimum walk distance of the request with at least one other minimum walk distance of another ride-sharing request; and
transmit an offer for the selected route, the offer including a fare, the fare being discounted from a regular fare, the pick-up location, drop-off location, and time window, wherein the amount of discount increasing as the maximum walk distance increases, wherein the discount increases as the number of other ride-sharing requests that overlap with the maximum walk distance increases.
